(19) United States
(12) Patent Application Publication
(10) Pub. No.: US 2019/0138329 A1
(43) Pub. Date: May 9, 2019

(54) USER INTERFACE FOR EFFICIENT USER-SOFTWARE INTERACTION

(71) Applicant: Dharma Platform, Inc., Washington, DC (US)

(72) Inventors: Jesse Erin Berns, Washington, DC (US); Jennifer Paige Griffin, Chicago, IL (US); David Barros Sieeea Cordera, Washington, DC (US)

(21) Appl. No.: 15/892,068

(22) Filed: Feb. 8, 2018

Related U.S. Application Data
(60) Provisional application No. 62/599,446, filed on Dec. 15, 2017.
(60) Provisional application No. 62/582,403, filed on Nov. 7, 2017.

(51) Int. Cl. G06F 9/451; G06F 3/0485; G06F 3/0482

(52) U.S. Cl. CPC G06F 9/451; G06F 3/0485; G06F 3/167; G06F 2203/04803; G06F 3/0482

(57) ABSTRACT

Disclosed here are systems and methods for enabling efficient user-software interface and easy discoverability of the functionality of the software. In some embodiments, the depth of the nested user interface elements is limited to one, thus preventing the user from going down the rabbit hole of nested menus having multiple sub-nested menus to find a single functionality. In other embodiments, there are no nested menus, and majority of the user interaction is performed through an action bar or a set of easily accessible user interface elements such as buttons representing the most common commands available in the given state of the software application. The action bar can receive commands through typing or voice, and can also present the set of most common commands currently available in the software application.

### CROSS-REFERENCE TO RELATED APPLICATIONS

This application claims priority to the U.S. provisional patent application Ser. No. 62/599,446 filed Dec. 15, 2017, and the U.S. provisional patent application Ser. No. 62/582,403 filed Nov. 7, 2017, all of which are incorporated herein by this reference in their entirety.

### TECHNICAL FIELD

The present application is related to user interfaces, and more specifically to methods and systems that enable efficient user-software interaction.

### BACKGROUND

Today's user interfaces for software applications have predominantly become graphical user interfaces. The graphical user interface (GUI) allows users to interact with electronic devices through graphical icons and visual indicators, instead of text-based user interfaces, typed command labels or text navigation. GUIs were introduced in reaction to the perceived steep learning curve of command-line interfaces which require commands to be typed on a computer keyboard. The actions in a GUI are usually performed through direct manipulation of the user interface elements. The proliferation of the GUI elements such as menus, tabs, buttons etc. within a single GUI has created user interfaces with elaborate sets of nested elements which expose the complexity of the underlying software, intimidate the user, and hinder the user's ability to discover even the simple the functions needed to perform a task.

### SUMMARY

Disclosed here are systems and methods for enabling efficient user-software interface and easy discoverability of the functionality of the software. In some embodiments, the depth of the nested user interface elements is limited to one, thus preventing the user from going down the rabbit hole of nested menus having multiple sub-nested menus to find a single functionality. In other embodiments, there are no nested menus, and majority of the user interaction is performed through an action bar or a set of easily accessible user interface elements such as buttons representing the most common commands available in the given state of the software application. The action bar can receive commands through typing or voice, and can also present the set of most common commands currently available in the software application.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 shows a user interface enabling efficient user-software interaction, according to one embodiment.

FIG. 2 shows multiple states of a software application.

FIG. 3 shows a user interface displaying the most common commands associated with the state of the software.

FIGS. 4A-4B show a user interface enabling efficient user-software interaction, according to additional embodiments.

FIGS. 5A-5B shows a user interface enabling efficient user-software interaction, according to another set of embodiments.

FIG. 6A shows a system to enable efficient user-software interaction by running part of the software on a user device, and the other part of the software on a server.

FIG. 6B shows a system to enable efficient user-software interaction by running the software 200 in FIG. 2 fully on the server.

FIG. 7 is a flowchart of a method to enable efficient user-software interaction, and easy discoverability of the user interface.

FIG. 8 is a flowchart of a method to enable efficient use of the user interface, and easy discoverability of the user interface.

FIG. 9A shows a data structure used in tracking a number of nested user interface elements, according to one embodiment.

FIG. 9B shows a data structure used in tracking a number of nested user interface elements, according to another embodiment.

FIG. 10 is a diagrammatic representation of a machine in the example form of a computer system within which a set of instructions, for causing the machine to perform any one or more of the methodologies or modules discussed herein, may be executed.

### DETAILED DESCRIPTION

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### User Interface

Disclosed here are systems and methods for enabling efficient user-software interface and easy discoverability of the functionality of the software. In some embodiments, the depth of the nested user interface elements is limited to one, thus preventing the user from going down the rabbit hole of nested menus having multiple sub-nested menus to find a single functionality. In other embodiments, there are no nested menus, and majority of the user interaction is performed through an action bar or a set of easily accessible user interface elements such as buttons representing the most common commands available in the given state of the software application. The action bar can receive commands through typing or voice, and can also present the set of most common commands currently available in the software application.

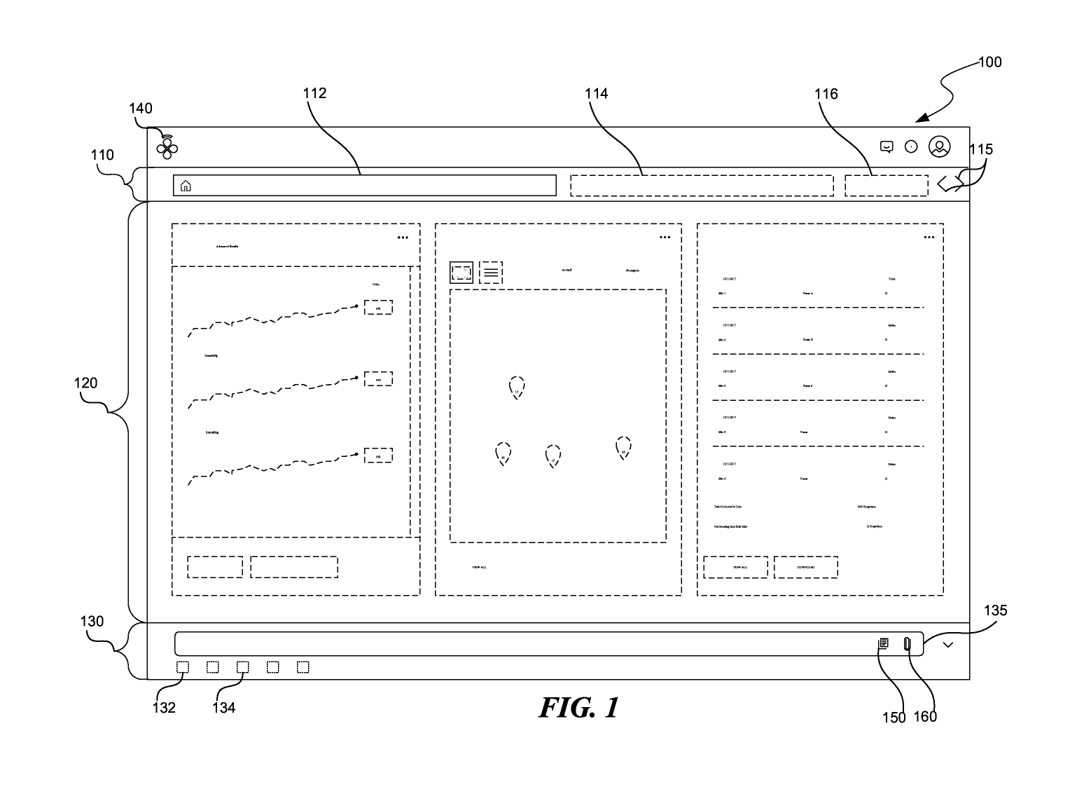

FIG. 1 shows a user interface enabling efficient user-software interaction, according to one embodiment. The dotted lines in FIG. 1 represent optional elements. The user interface 100 facilitates communication between the user and a software application (“software”). The user interface has at least three sections 110, 120, 130. Out of the three sections, section 130 is the only section that can receive multiple user inputs. Section 120 can display an output associated with a command entered into the section 130.

The user interface 100 is persistently configured into at least three sections in every embodiment of the user interface 100. In a first set of embodiments of the user interface 100, the three sections are always in the same place, in a second set of embodiments of the user interface 100, the three sections are substantially in the same place, while in a third set of embodiments of the user interface 100 the three sections are substantially replaced by other user interface elements, while at least an indication of the three sections is always visible.

In some embodiments of the user interface 100, sections 110, 120, 130 contain no user interface elements, such as buttons, menus, tabs, etc., aside from a command line entry in section 120. In some other embodiments, sections 110, 120, 130 contain no user interface elements which are nested. In other words, there are no user interface elements which when activated present another user interface element to be activated. For example, there are no nested menus. In a third set of embodiments, an element 140 of the user interface 100 independent of the sections 110, 120, 130 can be nested to one level. In other words, the element 140, when activated, can present a set of user interface elements, which in turn, when activated do not provide a second level of user interface elements, but instead perform a command associated with the user interface element.

Section 110 is the informational section displaying information regarding a state of a computer such as advertisements, computational resource consumption by all the applications currently running on the computer, etc. Section 110 can also display information regarding the state of the software such as computational resource consumption by the software displaying the user interface 100, or by the user interface 100. Additionally, section 110 can display information regarding the state of a project viewed by the user, such as staffing of the project, how complete the project is, geographical area of the project, access permissions to the project, etc.

Section 110 can also display history of commands 112, 114, 116 entered by the user into the software, arranged in an order in which the history of commands 112, 114, 116 was entered by the user. Section 110 can include a user interface element 115 which allows the user to scroll through the history of commands. For example, the user interface element 115 can be an arrow or a scroll wheel, or any other kind of icon, allowing the user to go backward and forward in the history of commands.

Section 110 can occasionally be capable of receiving a user input through the user interface element 115. In other words, section 110 can in some embodiments of the user interface 100 can receive user inputs, while in other embodiments of the user interface 100, section 110 cannot receive user inputs. By contrast, section 120 can be passive, i.e., not configured to receive any user inputs in every embodiment of the user interface 100.

Section 130 is the only one of the three sections that can receive multiple inputs from the user in every embodiment of the user interface 100. Section 130 includes a user interface element 135, such as an action bar, to receive a typed or a spoken command from the user. In addition, section 130 can contain elements 132, 134 (only two labeled for brevity), such as buttons, which correspond to the most common commands. The most common commands can be most common commands entered by the user, the most common commands entered by a group of users similar to the user, or the most common commands entered by all the users, within the given state of the software. The most common commands can be “new program”, “change program type”, “create a new project”, etc.

User interface element 150 when activated, by clicking or a voice command, can also display the most common commands associated with the given state of the software. User interface element 160, when activated, by clicking or a voice command, can import a file outside of the software application into the software application. The file can contain data that can later be analyzed by the software application.

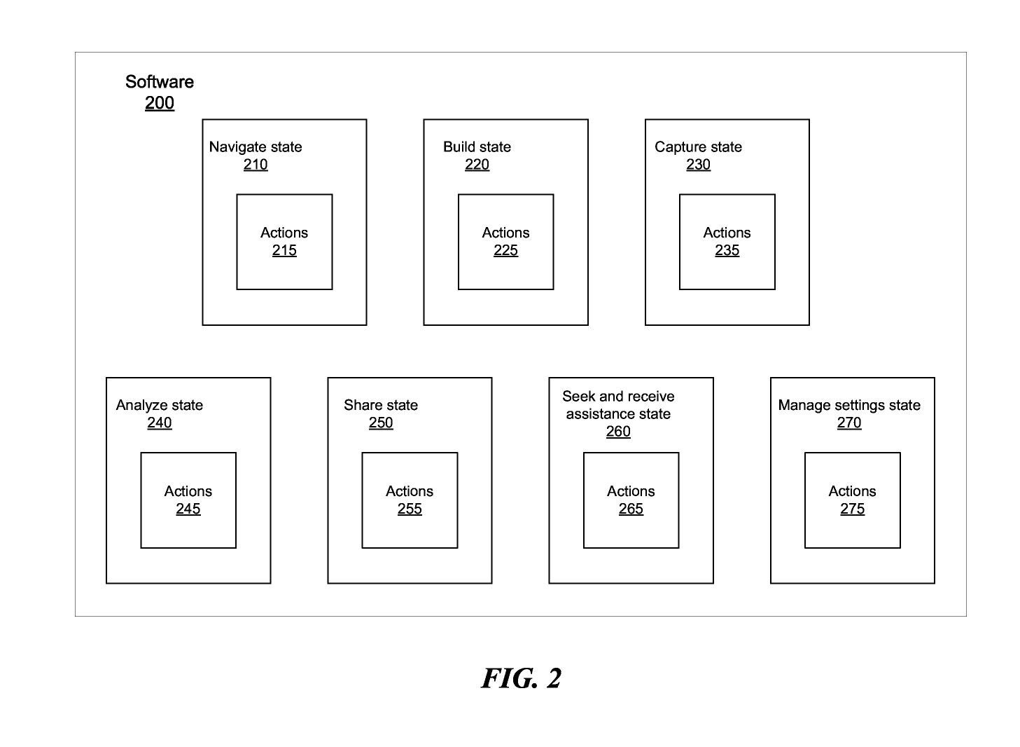

FIG. 2 shows multiple states of a software application. The software 200 can include seven different states: a navigate state 210, a build state 220, a capture state 230, an analyze state 240, a share state 250, a seek and receive assistance state 260, and a manage settings state 270. These seven types of user-software interactions describe the core usage patterns of every day software users, regardless of sector. In the navigate state 210, the user can navigate through files associated with the user, and find words, phrases and/or other objects defined within the software 200.

In the build state 220, the user can create content within the software 200. For example, in the build state 220 the user can design a questionnaire to gather data regarding, for example, frequency of a particular disease in a particular area. In the capture state 230 the same user, or another user, can gather information to input into the software 200. For example, the user can collect answers to the questionnaire created in the build state 220.

In the analyze state 240, the user can examine the data associated with the user within the software 200. For example, the user can analyze the frequency of disease by season, by region, by socio-economic status, etc. In the share state 250, the user can share with others various aspects of the data associated with the user within the software 200. For example, the user can share the results of his analysis on Twitter, Facebook, Google docs, email, etc.

In the seek and receive assistance state 260, the user can submit requests for help to technical support associated with the software 200, or to a group of users associated with the software 200. In the manage settings state 270, the user can: define one or more projects associated with the user within the software 200; additional users associated with the project, and their roles; the duration of the project, etc.

Each state 210, 220, 230, 240, 250, 260, 270 has a corresponding set of actions 215, 225, 235, 245, 255, 265, 275 that can be performed when the software 200 is in the corresponding state 210, 220, 230, 240, 250, 260, 270, respectively. Each action includes a command to be executed by the software 200, and an optional one or more parameters associated with the command.

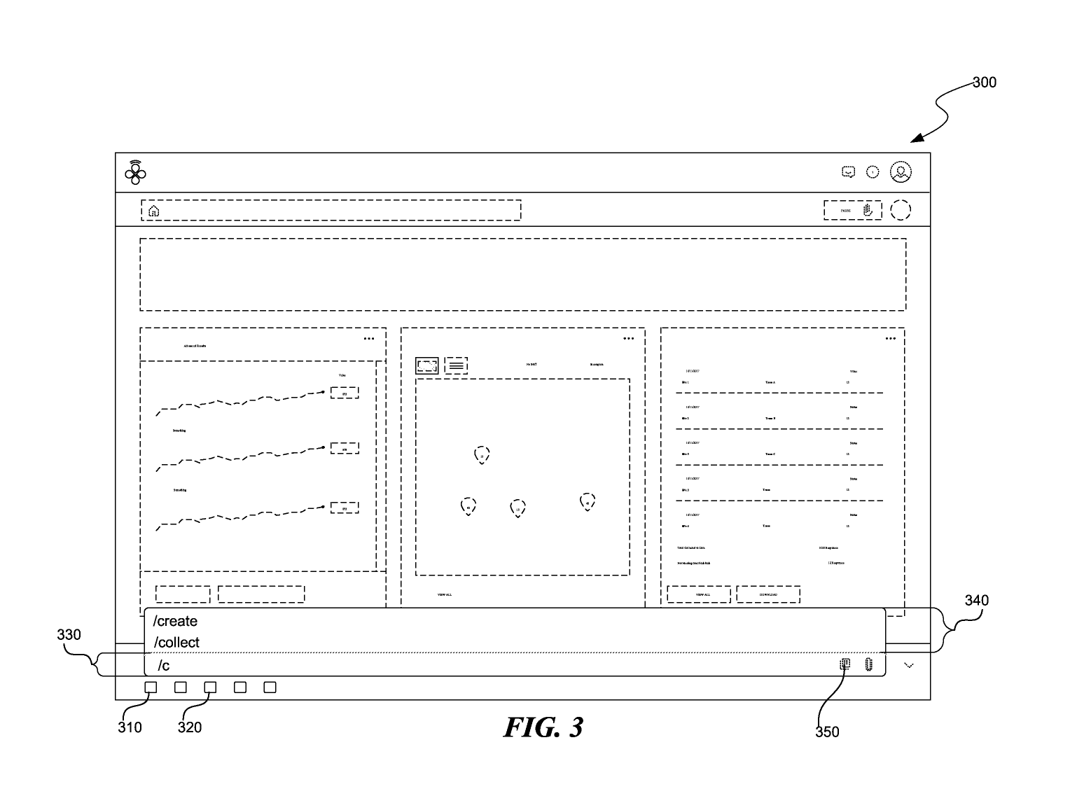

FIG. 3 shows a user interface displaying the most common commands associated with the state of the software. The user interface 300 can display the most common commands in multiple ways, such as the user interface elements 310, 320 (only two labeled for brevity), the user interface element 340, the user interface element 350.

User interface elements 310, 320 can be buttons as shown in FIG. 3, can correspond to the most common commands, and can be updated as the most common commands change. By activating the user interface elements 310, 320, such as clicking the user interface element 310, 320, the command associated with the activated user interface element is executed.

The user interface element 330 can be an action bar as shown in FIG. 3. The user interface element 330 can be activated by hovering a cursor, by clicking on the user interface element 330, and/or beginning to enter an input through text or voice, etc. When the user interface element 330 is activated, the user interface element 340 can appear and list multiple most common commands. The list can be updated as most common commands change, or if further input to the action bar 330 is received. Displaying the most common commands, whether through the user interface element 340, or buttons 310, 320, enables efficient use of the user interface and easy discovery of the functionality of the software. As a result, computational resources, such as central processing unit cycles, graphics processing unit cycles etc., are preserved because displaying unnecessary menus, and sub-menus, and executing unnecessary commands while the user is discovering the user interface are avoided.

The user interface element 350 can be an icon such as shown in FIG. 3, which when activated, by hovering or clicking with the cursor, can display the most common commands associated with the given state of the software.

The software can determine the state of the software and multiple actions available in the given state of the software, as described in this application. Based on the multiple actions available the processor determines the most common commands entered by the user or by multiple users. Based on the state of the software, the processor modifies the most common commands associated with the user interface elements 310, 320.

For example, commands associated with the buttons 310, 320 change depending on whether the software is in the navigate state 210, the build state 220, the capture state 230, the analyze state 240, the share state 250, the seek and receive assistance state 260, and the manage settings state 270, in FIG. 2. Further, the most common commands can be determined as the most common commands entered by the user, the group of users similar to the user, or by all the users.

For example, if the user is an expert user of the software 200 in FIG. 2, and has entered a number of commands in a given state above a specified threshold, the software 200 can determine the most common commands solely based on the commands entered by the user. The specified threshold can be for example 100 commands for each state of the software, or the threshold number of commands can vary depending on the state of the software. In a more specific example, the threshold number of commands can be specified as a percentage of a number of commands, such as 50%, available in the given state of the software. If a state of the software has a total of 10 commands available (e.g., the navigate state 210), then the threshold number of commands can be 5, while if a state of the software has a total of 500 commands available (e.g., the build state 220), then the threshold number of commands can be 250.

In another example, if the user has not entered the threshold number of commands, the most common commands can be determined by aggregating the commands entered by the user along with the commands entered by other users similar to the user, or by all the other users.

The user interface 300 can receive an activation event at the user interface element 330. The activation event can be a beginning of an entry of an input whether by voice or typing, or can be a hover and/or a click of a cursor. In response to the activation event, the user interface 300 can enlarge the user interface element 330 to obtain the user interface element 340 displaying the most common commands among the multiple commands available in the state of the software. For example, the user typing “/” serves as an indication that the following text is a command to the software 200 in FIG. 2. When the user interface element 330 receives “/” the user interface element can list the most common commands available in a given application state. After the user types in “/c”, the user interface element 340 can list the most common commands that begin with the letter “c”, such as “create”, “collect”, “compare”, etc.

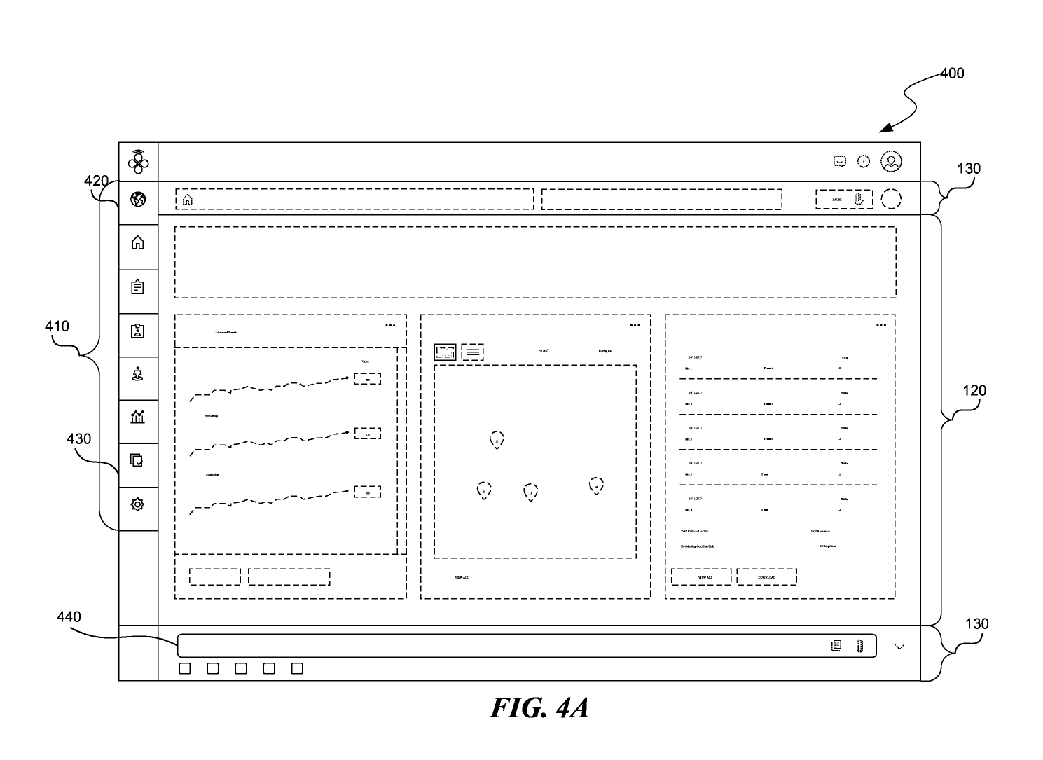

FIGS. 4A-4B show a user interface enabling efficient user-software interaction, according to additional embodiments. The user interface 400 can be the default user interface or the user interface 400 can be reached upon activating the user interface element 140 in FIG. 1. The user interface 400 contains user interface element 410, and the three sections 110, 120, 130, described in FIG. 1.

The position of the three sections 110, 120, 130 in user interface 400 is substantially similar to the position of the three sections 110, 120, 130 in user interface 100 in FIG. 1. As seen in FIGS. 4A-4B, the position of the three sections 110, 120, 130 has been slightly reduced and/or occluded by the user interface element 410. The user interface element 410 can be partially transparent and overlaid on top of the three sections 110, 120, 130, or can completely occlude the three sections 110, 120, 130.

The user interface element 410 can contain multiple additional user interface elements, such as buttons, 420, 430 (only two labeled for brevity), which when activated, by for example a mouse click or a voice activation, perform a command within the software application. The buttons 420, 430 can correspond to the states of the software as explained in FIG. 2, and when activated put the software in the corresponding state. The commands performed by the buttons 420, 430, can also be entered into and performed by the action bar 440.

The buttons 420, 430 are not nested, meaning, when they are activated the buttons 420, 430 do not produce additional menus or buttons for user to activate. In other words, the depth of the nested user interface element is limited to at most one nested user interface element. For example, if by clicking on user interface element 140 in FIG. 1, the user obtains the user interface element 410, the user interface element 140 is nested by one.

When the user activates the action bar 440, the extended action bar 450 can display the most common commands in the given state of the software as seen in FIG. 4B. The most common commands can be entered by the user, the group of users similar to the user, or by all the users of the software.

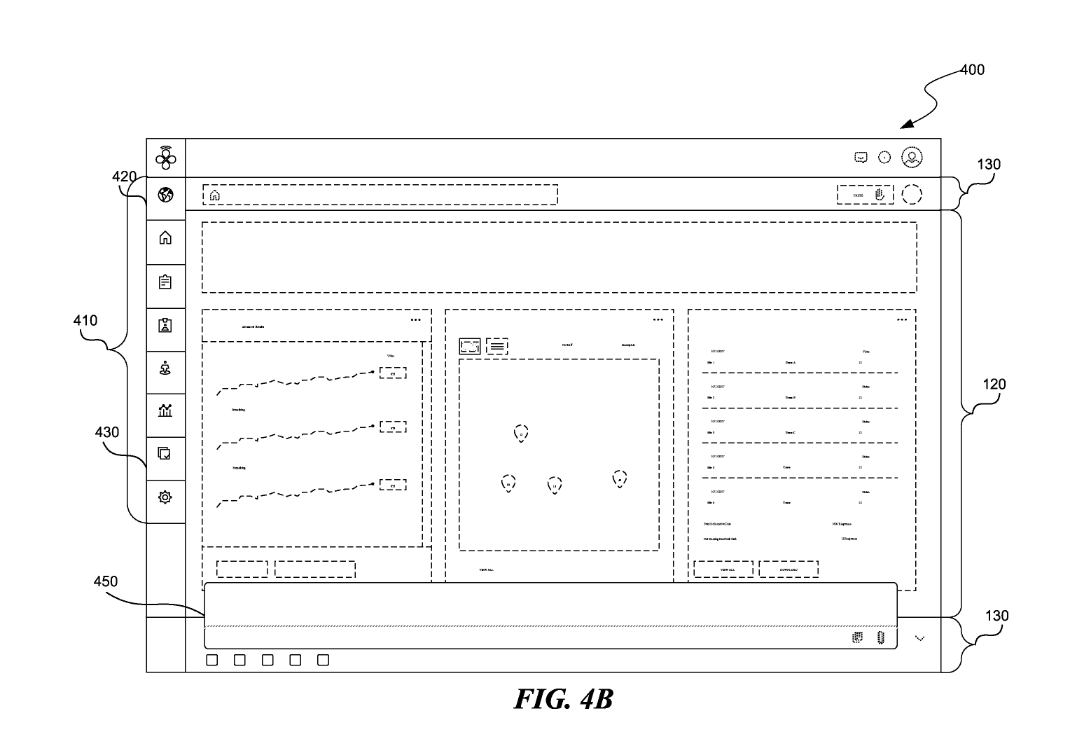

FIGS. 5A-5B shows a user interface enabling efficient user-software interaction, according to another set of embodiments. The user interface 500 is associated with the software 200 in FIG. 2, and can be shown on a display with a different aspect ratio and/or different size than the display showing user interfaces 100 in FIG. 1, 300 in FIG. 3, 400 in FIGS. 4A-4B. User interface 500 can be displayed on a mobile device such as a phone, a tablet, a personal digital assistant, etc.

The user interface 500 contains three sections 510, 520, 530, which correspond to sections 110, 120, 130 in FIG. 1. Section 510 displays information associated with the mobile device, software 200, the user, a project. Section 510 contains the user interface element 560, which when activated, for example by a mouse click, a finger press, etc., displays additional menus as shown in FIG. 5B. Section 520 displays the output of commands entered into the software 200.

Section 530 contains the action bar 540 which enables efficient interaction between the software and the user by allowing the user to enter typed commands or voice commands. For example, when the user provides a command to the action bar “/list my projects”, section 510 displays the entered command “my projects”, while section 520 displays the list of projects associated with the user.

Section 530 also enables easy discoverability of the user interface 500, by listing the most common commands associated with the given state of the software. For example, section 530 can provide a user interface element 550, which when activated, for example by clicking, provides the list of the most common commands to the user, by for example displaying the most common commands, or by providing the most common commands through audio.

When the user element 560 in section 510 is activated, the user interface element 570 in FIG. 5B is displayed showing various selectable buttons 580, 590 in FIG. 5B (only two labeled for brevity). The selectable buttons 580, 590, when activated, execute a command associated with the software, and do not produce any additional nested menus. The user interface element 570 can replace a portion of the two sections 520, 530, while preserving section 510. An indication of the two sections 520, 530 of the user interface 500 can be preserved, as shown in FIG. 5B. Additionally, a user element 505 is created, such as an arrow, within section 510 to enable the user to retract the user interface element 570, and go back to the display shown in FIG. 5A.

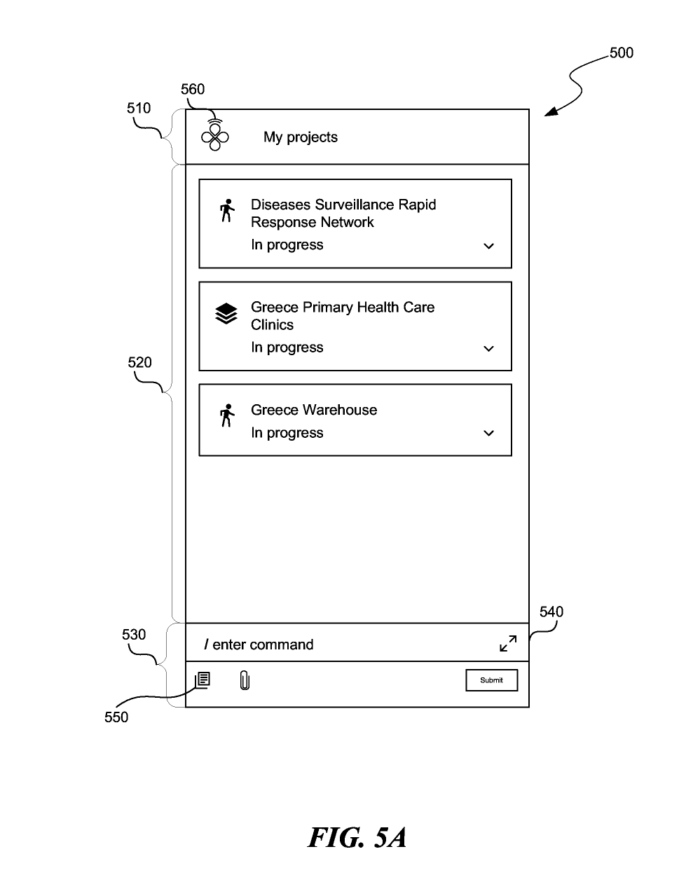

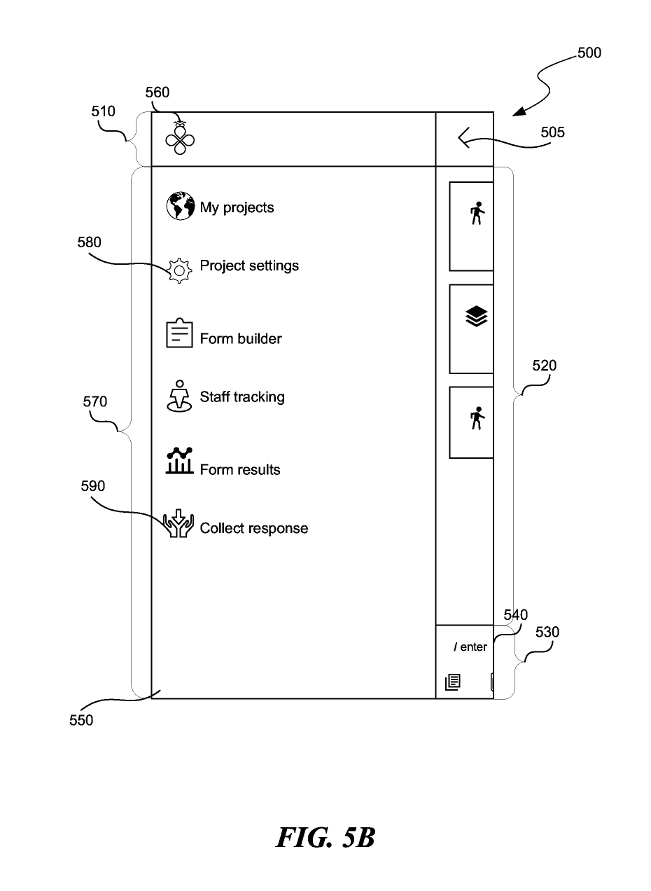

FIG. 6A shows a system to enable efficient user-software interaction by running part of the software 200 in FIG. 2 on a user device, and the other part of the software 200 on a server. The system includes a server 600, a device 610, and a communication network 620. The server 600 can include one or more cloud servers running at least a portion 200B of the software 200 in FIG. 2. Device 610 can be a mobile device, a desktop computer, a laptop computer, another server, etc. The server 600 and a device 610 communicate over the network 620 such as a cellular network, a local area network, a wide area network, a data network, a mesh network, etc.

The server 600 can include a database 630 storing various software available for download. Upon receiving a request to download a software, the server 600 can provide the software to the requesting device, such as device 610. The provided software can be software 200 in FIG. 2. In addition, the server 600 can include another database 640 which stores data associated with software 200.

The server 600 can run the portion 200B of the software 200. The portion 200B of the software 200 can receive a request from the device 610 to retrieve the data from the database 640, analyze the retrieve data, and provide a result of the analysis to the device 610. The device 610 can run a portion 200A of the software 200. Upon receiving the results of the analysis, the device 610 can display the results in section 110 in FIG. 1, 4A-4B, 520 in FIG. 5A-5B, as an output to be displayed in one of the three sections.

For example, software 200A can create the user interface, respond to user interface events, such as displaying a nested menu, receive inputs from the server, and/or perform traditionally inexpensive tasks such as sending a help request, sharing data with other users, etc. Software 200B can perform the computationally expensive tasks such as analyzing the received data, storing large amounts of data, performing natural language processing, determining most common commands to display in the user interface, etc.

The software 200B running on the server 600 can receive from the device 610 a state of the software 200A, and multiple various inputs from multiple users. For each state of the software 200, the software 200B can determine the most common commands, such as top five most common commands, entered into the software 200A, based on all the commands entered by all the users of the software. The software 200B can determine the most common commands based on the commands entered by the user, or by a group of users similar to the user. For example, when the user has interacted with the software 200A sufficiently to provide commands above a certain threshold, as described in this application, the software 200B can determine the most common commands based solely on the input provided by the user. Once the most common commands have been determined, the software 200B can provide the most common commands to the software 200A to present to the user.

FIG. 6B shows a system to enable efficient user-software interaction by running the software 200 in FIG. 2 fully on the server. The system includes a database 670, the server 650 running the software application 200, and communicating with a device 660 over the network 620. The database 670 can store data associated with the software 200.

The server 650 performs almost all the computation associated with software 200. The device 660 does not need to download the software application 200A and instead can access the server 650 using a web browser. The device 660 receives multiple user inputs, and sends them to the server 650, which then processes the user inputs, and sends the responses back to the device 660.

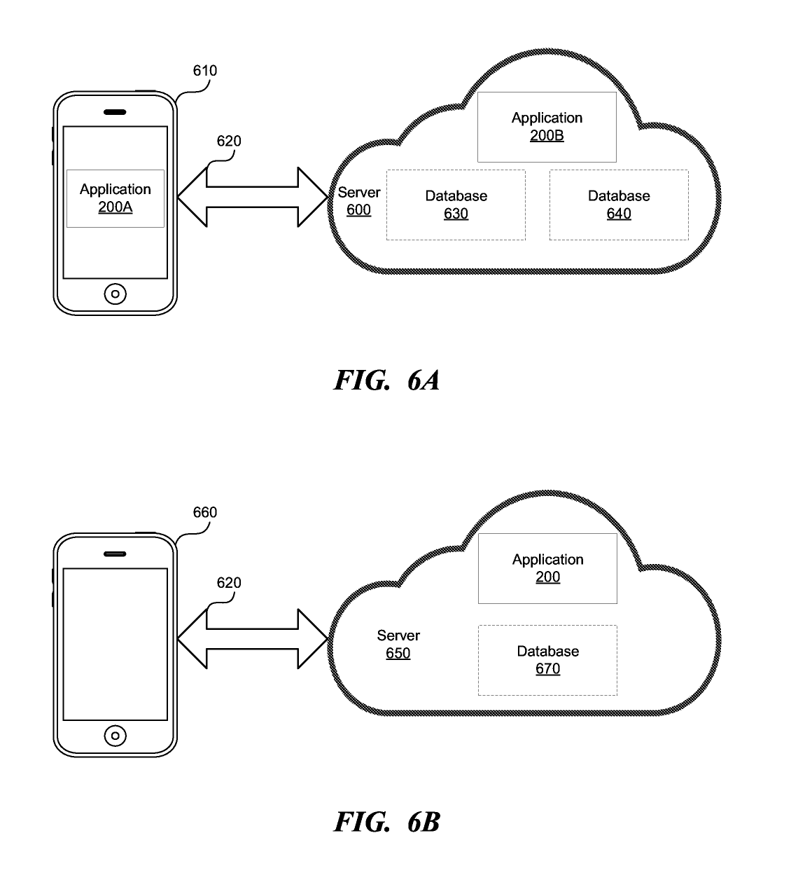

FIG. 7 is a flowchart of a method to enable efficient user-software interaction, and easy discoverability of the user interface. In step 700, a processor associated with the software 200 in FIG. 2 presents during a user-software interaction a user interface comprising three sections in substantially the same position, wherein only one of the three sections can receive multiple inputs from the user.

In step 710, the processor eliminates from the user interface, a nested menu. The nested menu includes a first element of the user interface configured to be selected and upon being selected displaying a second element of the user interface configured to be selected. The second element and the first element are substantially similar, and can both be menu entries, tabs, buttons, cards, etc.

In step 720, the processor enables easy discovery of the user interface by informing the user of most common commands within the only one of the three sections that can receive multiple inputs from the user.

The processor can configure a first section of the three sections to display multiple commands entered by the user arranged in an order in which the multiple commands were entered by the user. Further, the processor can configure a second section of the three sections to display an output associated with a command entered into the only one of the three sections that can receive multiple inputs from the user. Finally, the processor can configure the only one of the three sections that can receive multiple inputs from the user to include a user interface element able to receive a typed or a spoken command.

The processor can provide, within the only one of the three sections that can receive multiple inputs from the user, multiple user interface elements corresponding to the most common commands. Based on a state of a software receiving multiple inputs from the user, the processor can modify the most common commands associated with multiple user interface elements. The most common commands can be entered by the user, by a group of users similar to the user, or by all the users.

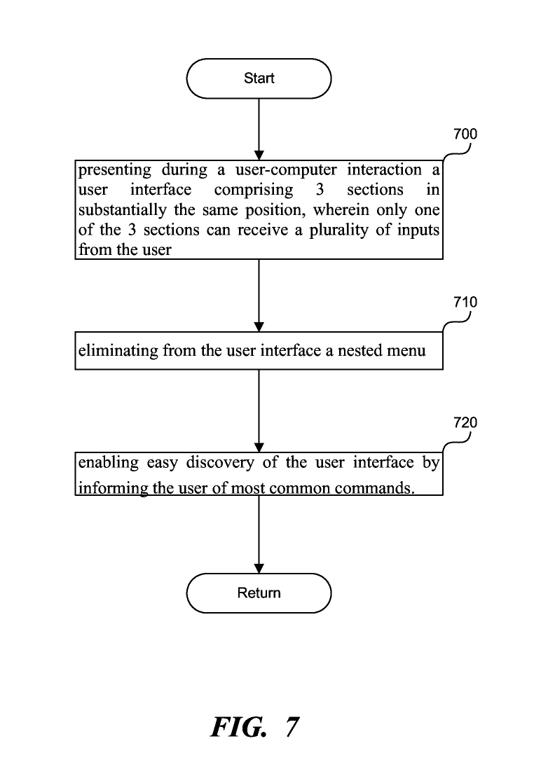

FIG. 8 is a flowchart of a method to enable efficient use of the user interface, and easy discoverability of the user interface. In step 800, a processor associated with the software 200 in FIG. 2 presents a user interface to a user. The processor can be a central processing unit and/or a graphics processing unit. The user interface includes three sections, where only one of the three sections can consistently receive multiple inputs from the user. In other words, only one of the three sections can receive multiple inputs from the user in every embodiment of user interface. The other two sections of the user interface can in some embodiments receive multiple inputs, but in some embodiments they can receive only one input, or no inputs at all.

In step 810, the processor limits a depth of a nested user interface element to at most one nested user interface element using a data structure and/or a function tracking a number of nested elements. The processor configures a first element of the user interface to display a second element of the user interface upon activating. The second element is substantially similar to the first of the user interface. Upon activating the second element, no further user interface elements are displayed, but instead, the software 200 performs the action specified by the second element. The activation of user interface elements can be a voice selection, a press, such as a mouse click or a finger touch, etc.

In step 820, the processor enables efficient use of the user interface and easy discovery of the user interface functionality by informing the user of most common commands within the section of the user interface that can consistently receive multiple inputs from the user. The most common commands can be displayed to the user or spoken to the user. When displayed, the most common commands can be buttons within the user interface, a list within the user interface, a drop-down menu, etc.

The processor can configure a first section of the three sections to display information regarding a state of a computer, a state of the software 200, a state of the project associated with the user, etc. The state of the computer can include computational resource consumption, while the state of the software 200 can include computational resource consumption by the software 200. The state of the project can include project staffing, how complete the project is, geographical area of the project, list of users who have a permission to view the project, etc. The first section can also display advertisements.

The processor can configure the first section of the three sections to display a history of commands entered by the user arranged in an order in which the commands were entered by the user. Further, the processor can enable browsing of the history of commands by displaying, within the first section, a user interface element configured to scroll through the history of commands when selected by the user. The user interface element can be an arrow or a wheel, or another kind of icon indicating browsing.

The processor can configure a second section of the three sections to display an output of a command entered into the only one of the three sections that can receive multiple inputs from the user. The output can be a comparison of two data sets, a list of received responses, an analysis of a data set, a graph of a data set over time, by response, by respondent, etc.

The processor can configure a third section of the three sections to be the only one of the three sections that can consistently receive multiple inputs from the user. The third section can include a user interface element to receive a typed or a spoken command, such as an action bar 135 in FIG. 1, 330 in FIG. 3, 440 in FIG. 4, 540 in FIGS. 5A-5B.

The processor can provide within the third section multiple user interface elements corresponding to the most common commands. For example, the processor can determine a state of a software and the commands available in the state of the software. Based on the commands available in the state of the software, the processor can determine the most common commands entered by the user or by multiple users. Finally, based on the state of the software, the processor can modify the most common commands associated with the multiple user interface elements. The multiple user elements can be buttons, can be a list, can be a menu, etc.

In another example to determine the most common commands, the processor can determine a state of the software and the commands available in the state of the software. The processor receives an activation event at the user interface element, such as a beginning of an entry of an input among multiple inputs, or a hover of a cursor. The processor enlarges the user interface element to display the most common commands among multiple commands available in the state of the software.

The processor can display the second element 410 in FIGS. 4A-4B of the user interface within a region occupied by the three sections of the user interface, while substantially preserving a position of the three sections during the user-software interaction, as shown in FIGS. 4A-4B. The second element 410 of the user interface contains no submenus.

The processor can display the second element of the user interface 570 in FIG. 5B by substantially replacing the three sections of the user interface, while preserving an indication of the three sections of the user interface, as shown in FIG. 5B. The second element of the user interface 570 contains no submenus. In addition, the processor can create a user interface element such as a button 505 in FIG. 5B to enable the user to go back to the previous state of the display.

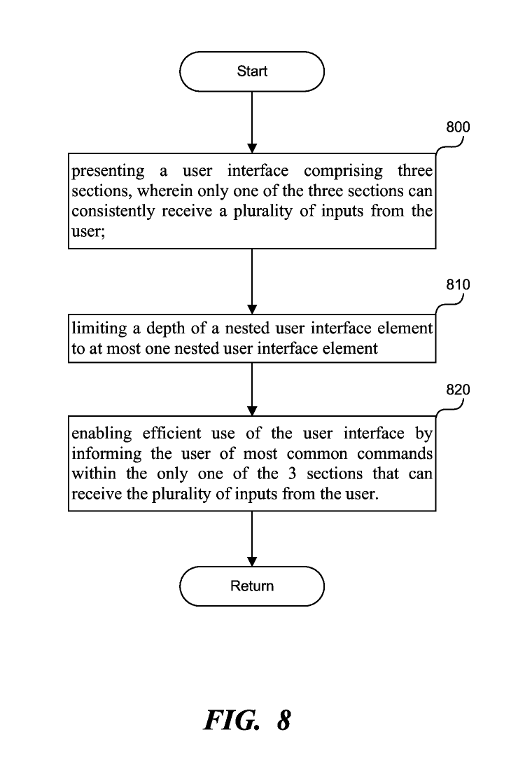

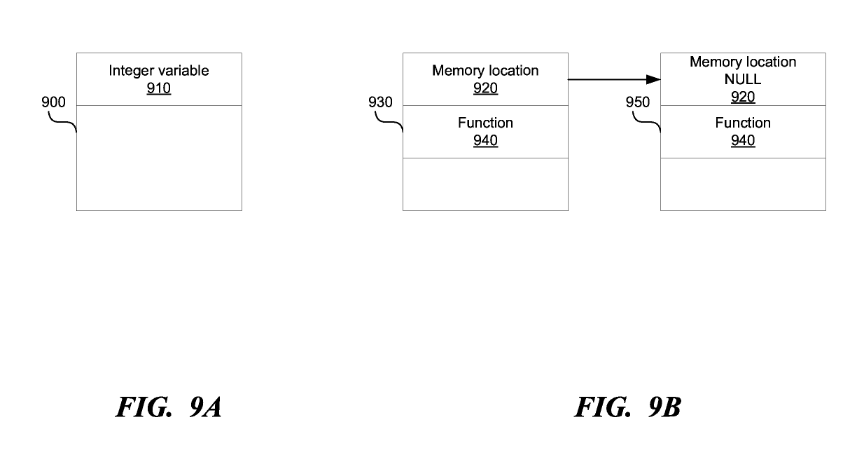

FIG. 9A shows a data structure used in tracking a number of nested user interface elements, according to one embodiment. The data structure 900 can include a variable 910 representing an existence of an ancestor data structure. The ancestor data structure can represent the user interface element, which when activated produces the user interface element represented by the data structure 900. For example, the ancestor data structure can represent user interface element 140 in FIG. 1, 560 FIGS. 5A-5B, which when activated, such as by pressing, or a voice command, produces the user interface element 410 in FIGS. 4A-4B, 570 in FIG. 5B.

The variable 910 can be an integer variable counting the number of ancestors that the data structure 900 has. When the value of the variable exceeds 1, the software 200 in FIG. 2 stops instantiating additional nested data structures 900. For example, the variable associated with the data structure representing the user interface element 140, 560 has a value of 0, because the user interface element 140, 560 is not nested, and does not have an ancestor data structure. The variable associated with the data structure representing the user interface element 410, 570 has a value 1, because the user interface element 410, 570 has one ancestor, namely the user interface element 140, 560.

FIG. 9B shows a data structure used in tracking a number of nested user interface elements, according to one embodiment. The data structure 930 can correspond to the user interface element 410, 570, while data structure 950 can correspond to the user interface element 140, 560. The variable 920, contained in the data structures 930, 950, can indicate a memory location of the immediate ancestor data structure, i.e., the parent data structure. Data structure 930 has an ancestor 950, the data structure 950 has no ancestors.

To determine a number of ancestors the data structure 930, 950 have, the data structure 930 can include a function 940 to determine a number of valid values contained in the variable 920. For example, the variable 920 associated with the data structure 930 contains a memory location of the data structure 950. The variable 920 associated with the data structure 950 representing user interface element 140, 560 contains an invalid memory location, such as a NULL memory location, indicating that the user interface element 140, 560 is not nested, and therefore has no parent. The function 940 can examine the ancestors of the data structure 930, by following the memory location 920, finding the data structure 950, increasing the ancestor counter by one, determining that the data structure 950 has no ancestors and returning the value of the ancestor counter, in this case 1. When the number of ancestors exceeds 1, the software 200 in FIG. 2 can cease to instantiate further child instances of the data structure 930, or deed the instances of the data structure that have more than one ancestor.

### Computer

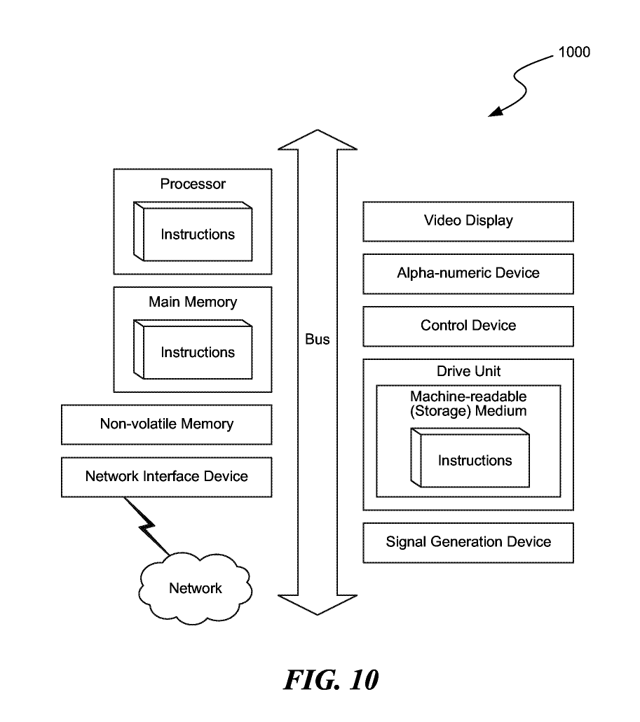

FIG. 10 is a diagrammatic representation of a machine in the example form of a computer system 1000 within which a set of instructions, for causing the machine to perform any one or more of the methodologies or modules discussed herein, may be executed.

In the example of FIG. 10, the computer system 1000 includes a processor, memory, non-volatile memory, and an interface device. Various common components (e.g., cache memory) are omitted for illustrative simplicity. The computer system 1000 is intended to illustrate a hardware device on which any of the components described in the example of FIGS. 1-9 (and any other components described in this specification) can be implemented. The computer system 1000 can be of any applicable known or convenient type. The components of the computer system 1000 can be coupled together via a bus or through some other known or convenient device.

The computer system 1000 can be the computer system of device 610, in FIG. 6A, 660 FIG. 6B, and/or can be the computer system of the server 600 and FIG. 6A, 615 FIG. 6B. The processor in FIG. 10 can be the processor configuring the user interface, tracking most common commands, receiving inputs from the user, and performing other steps described in this application. The processor in FIG. 10 can be the central processing unit, or the graphics processing unit. The main memory, the nonvolatile memory, and the drive unit in FIG. 10 can store the instructions described in this application, can store the data structures 900 in FIG. 9A, 930, 950 in FIG. 9B, and can store databases 630, 640 in FIG. 6A, 670 in FIG. 6B. The network interface in FIG. 10 can facilitate the communication over the network 620 in FIGS. 6A-6B. The alphanumeric device in FIG. 10 can receive user inputs. The video display in FIG. 10 can show the user interface 100 in FIG. 1, 300 in FIG. 3, 400 in FIGS. 4A-4B, 500 in FIGS. 5A-5B.

This disclosure contemplates the computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1000 may include one or more computer systems 1000; be unitary or distributed; span multiple locations; span multiple machines; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1000. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1000. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 10 reside in the interface.

In operation, the computer system 1000 can be controlled by operating system software that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. An apparatus comprising:
a storage medium storing computer executable instructions;
a processor to execute the computer executable instructions and to upon receiving a request to download a software, provide the software, the software to:
present a user interface comprising three sections, wherein only one of the three sections can consistently receive a plurality of inputs from a user;
limit a depth of a nested user interface element to at most one nested user interface element by configuring a first element of the user interface to activate and upon activating to display a second element of the user interface configured to activate, wherein the second element and the first element are substantially similar, and upon activating the second element to execute a command without displaying another element of the user interface; and
enable easy discovery of the user interface by informing the user of most common commands within the only one of the three sections that can receive the plurality of inputs from the user.

2. The apparatus of claim 1, comprising a database to store data associated with the software;
the processor to:
upon receiving the request from a device associated with the user, retrieve the data from the database, analyze the retrieved data; and
provide a result of the analysis as an output to be displayed in one of the three sections.

3. The apparatus of claim 1, comprising the processor to:
receive from a device associated with the user a state of the software and a plurality of various inputs from a plurality of users;
based on the plurality of various inputs from the plurality of users, determine the most common commands within the state of the software; and
provide the most common commands to the device associated with the user.

4. The apparatus of claim 1, comprising the processor to:
receive from a device associated with the user a state of the software receiving the plurality of inputs from the user and an input from the user;
determine when the plurality of inputs from the user exceeds a predetermined threshold;
based on the plurality of inputs from the user, determine the most common commands within the state of the software; and
provide the most common commands to the device associated with the user.

5. An apparatus comprising:
a processor;
a storage medium storing computer-executable instructions that, when executed by the processor, cause the apparatus to perform a computer-implemented operation, the instructions comprising:
instructions for presenting a user interface comprising three sections, wherein only one of the three sections can receive a plurality of inputs from a user;
instructions for limiting a depth of a nested user interface element to at most one nested user interface element by configuring a first element of the user interface to activate and upon activating to display a second element of the user interface configured to activate, wherein the second element and the first element are substantially similar, and upon activating the second element to execute a command without displaying another element of the user interface; and
instructions for informing the user of most common commands within the only one of the three sections that can receive the plurality of inputs from the user.

6. The apparatus of claim 5, comprising instructions for configuring a first section of the three sections to display information regarding a state of a computer or information regarding the state of a project viewed by the user.

7. The apparatus of claim 5, comprising instructions for configuring a first section of the three sections to display a plurality of commands entered by the user.

8. The apparatus of claim 7, comprising instructions for enabling browsing of the plurality of commands by displaying, within the first section, a user interface element configured to scroll through the plurality of commands when selected by the user.

9. The apparatus of claim 5, comprising instructions for configuring a second section of the three sections to display an output associated with a command entered into the only one of the three sections that can receive the plurality of inputs from the user.

10. The apparatus of claim 5, a third section of the three sections consisting of the only one of the three sections that can receive the plurality of inputs from the user, the third section comprising a user interface element to receive a typed or a spoken command.

11. The apparatus of claim 10, comprising:
instructions for providing, within the third section, a plurality of user interface elements corresponding to the most common commands.

12. The apparatus of claim 11, the instructions for providing the plurality of user interface elements comprising:
instructions for determining a state of a software receiving the plurality of inputs from the user and a plurality of commands available in the state of the software;
instructions for, based on the plurality of commands available, determining the most common commands entered by the user or by a plurality of users; and
instructions for, based on the state of the software, modifying the most common commands associated with the plurality of user interface elements.

13. The apparatus of claim 10, comprising:
instructions for determining a state of a software and a plurality of commands available in the state of the software;
instructions for receiving an activation event at the user interface element, the activation event comprising a beginning of an entry of an input in the plurality of inputs; and
instructions for enlarging the user interface element to display the most common commands among the plurality of commands available in the state of the software.

14. The apparatus of claim 5, comprising:
instructions for displaying the second element of the user interface within a region occupied by the three sections of the user interface, while substantially preserving a position of the three sections during a user-software interaction.

15. The apparatus of claim 5, comprising:
instructions for displaying the second element of the user interface by substantially replacing the three sections of the user interface, while preserving an indication of the three sections of the user interface.

16. An apparatus comprising:
a storage medium storing computer-executable instructions and data associated with the computer executable instructions;
a first processor to present a user interface comprising three sections, wherein only one of the three sections can consistently receive a plurality of inputs from a user; and
a first processor to:
instantiate a data structure representing a user interface element associated with the user interface and tracking a number of nested user interface elements;
enable easy discovery of the user interface by informing the user of most common commands within the only one of the three sections of the user interface that can consistently receive the plurality of inputs from the user.

17. The apparatus of claim 16, the first processor comprising graphics processing unit, and the second processor comprising a central processing unit.

18. The apparatus of claim 16, the storage medium comprising a cache memory.

19. The apparatus of claim 16, the data structure comprising a variable representing an existence of an ancestor data structure associated with the data structure.

20. The apparatus of claim 19, the data structure comprising a function limiting the existence of the ancestor data structure to one.

21. The apparatus of claim 19, the data structure comprising a function recursively traversing the variable representing the existence of the ancestor data structure to determine a number of ancestor data structures.

22. A user interface comprising:
a first section to display a plurality of commands entered by a user arranged in an order in which the plurality of commands was entered by the user, the first section occasionally capable of receiving a user input;
a second section to display an output associated with a command entered into a third section;
the third section comprising a user interface element to receive the command, the third section consistently capable of receiving the user input, and
wherein the first section is occasionally capable of receiving the user input, the second section is incapable of receiving the user input, and the third section is consistently capable of receiving the user input.

23. The user interface of claim 22, wherein the first, the second, and the third section are located in a substantially same position in each embodiment of the user interface.

24. The user interface of claim 22, the first section comprising the user interface element to receive the user input and to enable the user to browse the plurality of commands.

25. The user interface of claim 22, the third section comprising a second user interface element representing a most common command associated with a current state of the user interface.

26. The user interface of claim 25, the second user interface element comprising a button.

27. The user interface of claim 25, the second user interface element comprising a window appearing upon activation and indicating the most common command.

28. The user interface of claim 22, comprising a second user interface element providing a plurality of user interface elements upon activation.

29. The user interface of claim 28, the plurality of user interface elements comprising a plurality of buttons.

30. The user interface of claim 28, the plurality of user interface elements partially occupying a location associated with the first section, the second section, and the third section of the user interface.
